(19) United States
(12) Patent Application Publication
(10) Pub. No.: US 2019/0035082 A1
(43) Pub. Date: Jan. 31, 2019

(54) VISIBLE LIGHT COMMUNICATION (VLC) VIA DIGITAL IMAGER

(71) Applicant: QUALCOMM Incorporated, San Diego, CA (US)

(72) Inventors: Ravi Shankar Kadambala, Hyderabad (IN); Bapineedu Chowdary Gummadi, Hyderabad (IN); Vivek Veenam, Hyderabad (IN)

(21) Appl. No.: 15/664,135

(22) Filed: Jul. 31, 2017

(51) Int. Cl. G06T 7/11; H04B 10/116

(52) U.S. Cl. CPC G06T 7/11; G06T 2207/20021; H04B 10/116

(57) ABSTRACT

Briefly, one particular example implementation is directed to an apparatus including a digital imager. The digital imager, in the example implementation, includes an array of pixels to capture an image frame. At least some pixels are to measure light component signals for an image and are also to measure Visible Light Communication (VLC) signals. Circuitry to crop an image frame of light signal measurements is included so that, for light signal measurements that remain after cropping, extraction of VLC signal measurements from light component signal measurements is able to be employed. It should be understood that the aforementioned implementation is merely an example implementation, and claimed subject matter is not necessarily limited to any particular aspect thereof.

### BACKGROUND

### 1. Field

The present disclosure relates generally to visible light communication (VLC) via a digital imager (DI).

### 2. Information

Recently, wireless communication employing light emitting diodes (LEDs), such as visible light LEDs, has been developed to complement radio frequency (RF) communication technologies. Light communication, such as Visible Light Communication (VLC), as an example, has advantages in that VLC enables communication via a relatively wide bandwidth. VLC also potentially offers reliable security and/or low power consumption. Likewise, VLC may be employed in locations where use of other types of communications, such as RF communications, may be less desirable. Examples may include in a hospital or on an airplane.

### SUMMARY

Briefly, one particular example implementation is directed to an apparatus including a digital imager (DI). Herein, the terms imager, imaging device or the like are intended to refer to a digital imager (DI). The digital imager, in the example implementation, includes an array of pixels to capture an image frame. At least some pixels are to measure light component signals for an image and are also to measure Visible Light Communication (VLC) signals. Circuitry to crop an image frame of light signal measurements is included so that, for light signal measurements that remain after cropping, extraction of VLC signal measurements from light component signal measurements is able to be employed.

Another particular implementation is directed to an apparatus comprising: means for exposing an array of pixels to light signals; means for measuring the light signals impinging upon the array of pixels, wherein one or more of the measured light signals impinging upon the array of pixels include one or more measurements of one or more light signal components for an image and also include one or more measurements of visible light communication (VLC) signals; and means for cropping the measured light signals impinging upon the array of pixels so that remaining measured light signals include the one or more measurements of one or more light signal components for the image and include the one or more measurements of VLC signals.

Another particular implementation is directed to a method comprising: measuring light signals impinging upon an array of pixels of a digital imager, wherein at least one or more of the measured light signals impinging upon the array of pixels include one or more measurements of one or more light signal components for an image and also include one or more measurements of visible light communication (VLC) signals; cropping the measured light signals impinging upon the array of pixels so that remaining measured light signals include the one or more measurements of one or more light signal components for the image and also include the one or more measurements of VLC signals; and further processing the remaining measured light signals that include the one or more measurements of one or more light signal components for the image and also include the one or more measurements of VLC signals to extract the one or more measurements of VLC signals.

Another particular implementation is directed to a non-transitory storage medium comprising executable instructions stored thereon, the instructions being accessible from the non-transitory storage medium as physical memory states on one or more physical memory devices, the one or more physical memory devices to be coupled to one or more processors able to execute the instructions stored as physical memory states, one or more of the physical memory devices also able to store binary digital signal quantities, if any, as physical memory states, that are to result from execution of the executable instructions on the one or more processors; wherein the executable instructions to: measure light signals to imping upon an array of pixels, wherein at least one or more of the measured light signals to imping upon the array of pixels to include one or more measurements of one or more light signal components for an image and also to include one or more measurements of visible light communication (VLC) signals; crop the measured light signals to imping upon the array of pixels so that measured light signals to remain include the one or more measurements of one or more light signal components for the image and also include the one or more measurements of VLC signals; and further process the measured light signals to remain for extraction the one or more measurements of VLC signals.

It should be understood that the aforementioned implementations are merely example implementations, and that claimed subject matter is not necessarily limited to any particular aspect thereof.

### BRIEF DESCRIPTION OF THE DRAWINGS

Claimed subject matter is particularly pointed out and distinctly claimed in the concluding portion of the specification. However, both as to organization and/or method of operation, together with objects, features, and/or advantages thereof, it may best be understood by reference to the following detailed description if read with the accompanying drawings in which:

FIG. 1 is a schematic diagram illustrating an embodiment of one architecture for a system including a digital imager;

FIG. 2 is a flow diagram of actions to process light signals according to an embodiment;

FIG. 3 is another flow diagram of actions to process light signals according to another embodiment;

FIG. 4 is a schematic diagram illustrating another embodiment of an architecture for a system including a digital imager; and

FIG. 5 is a schematic diagram illustrating features of a mobile device according to an embodiment.

Reference is made in the following detailed description to accompanying drawings, which form a part hereof, wherein like numerals may designate like parts throughout that are corresponding and/or analogous. It will be appreciated that the figures have not necessarily been drawn to scale, such as for simplicity and/or clarity of illustration. For example, dimensions of some aspects may be exaggerated relative to others. Further, it is to be understood that other embodiments may be utilized. Furthermore, structural and/or other changes may be made without departing from claimed subject matter. References throughout this specification to “claimed subject matter” refer to subject matter intended to be covered by one or more claims, or any portion thereof, and are not necessarily intended to refer to a complete claim set, to a particular combination of claim sets (e.g., method claims, apparatus claims, etc.), or to a particular claim. It should also be noted that directions and/or references, for example, such as up, down, top, bottom, and so on, may be used to facilitate discussion of drawings and are not intended to restrict application of claimed subject matter. Therefore, the following detailed description is not to be taken to limit claimed subject matter and/or equivalents.

### DETAILED DESCRIPTION

References throughout this specification to one implementation, an implementation, one embodiment, an embodiment, and/or the like means that a particular feature, structure, characteristic, and/or the like described in relation to a particular implementation and/or embodiment is included in at least one implementation and/or embodiment of claimed subject matter. Thus, appearances of such phrases, for example, in various places throughout this specification are not necessarily intended to refer to the same implementation and/or embodiment or to any one particular implementation and/or embodiment. Furthermore, it is to be understood that particular features, structures, characteristics, and/or the like described are capable of being combined in various ways in one or more implementations and/or embodiments and, therefore, are within intended claim scope. In general, of course, as has always been the case for the specification of a patent application, these and other issues have a potential to vary in a particular context of usage. In other words, throughout the disclosure, particular context of description and/or usage provides helpful guidance regarding reasonable inferences to be drawn; however, likewise, “in this context” in general without further qualification refers to the context of the present disclosure.

A typical VLC system generally may include various VLC devices, such as a light source, which may, for example, comprise an access point (AP), such as a base station, for example. Alternatively, however, as discussed below, for one directional communication, e.g., a downlink without an uplink, for example, a modulating light source may be available that does not necessarily comprise an access point. Likewise, a VLC terminal may comprise a VLC receiver that does not necessarily otherwise communicate (e.g., transmit) VLC signals, for example. Nonetheless, a VLC terminal may, in an example embodiment, likewise comprise a portable terminal, such as a cellular phone, a Personal Digital Assistant (PDA), a tablet device, etc., or a relatively fixed terminal, such as a desktop computer. For situations employing a AP and a VLC terminal in which communication is not necessarily one directional, such as having an uplink and a downlink, so to speak, for example, a VLC terminal may also communicate with another VLC terminal by using visible light in an embodiment. Furthermore, a VLC system may also in some situations be used effectively in combination with other communication systems employing other communication technologies, such as systems using a variety of possible wired and/or wireless signal communication approaches.

VLC signals may use light intensity modulation for communication. VLC signals, which may originate from a modulating light source, may, for example, be detected and decoded by an array of photodiodes, as one example. However, a digital imager having electro-optic sensors, such as complementary metal oxide semiconductor (CMOS) sensors and/or charge coupled device (CCD) sensors, may include a capability to communicate via VLC signals in a similar manner (e.g., via detection and decoding). Likewise, a digital imager may be included within another device, which may be mobile in some cases, such as a smart phone, a tablet or may be relatively fixed, such as a desktop computer, etc.

However, default exposure settings for a digital imager, for example, may more typically be of use in digital imaging (e.g., digital photography) rather than for use in VLC signal communication. As such, default exposure settings may in some cases result in attenuation of VLC signals with a potential to possibly render VLC signals undetectable and/or otherwise unusable for communications. Nonetheless, as described, a digital imager (DI) may be employed, in an embodiment, in a manner that may permit VLC signal communication to occur, which may be beneficial, such as in connection with position/location determination(s), for example.

Global navigation satellite system (GNSS) and/or other like satellite positioning systems (SPSs) have enabled navigation services for mobile devices, such as handsets, in typically outdoor environments. However, satellite signals may not necessarily be reliably received and/or acquired in an indoor environment; thus, different techniques may be employed to enable navigation services for such situations. For example, mobile devices typically may obtain a position fix by measuring ranges to three or more terrestrial wireless access points, which may be positioned at known locations. Such ranges may be measured, for example, by obtaining a media access control (MAC) identifier or media access (MAC) network address from signals received from such access points and by measuring one or more characteristics of signals received from such access points, such as, for example, received signal strength indicator (RSSI), round trip delay (RTT), etc., just to name a few examples.

However, it may likewise be possible to employ Visible Light Communication technology as an indoor positioning technology, using, for example, in one example embodiment, stationary light sources comprising one or more light emitting diodes (LEDs). In an example implementation, fixed LED light sources, such as may be used in a light fixture, for example, may broadcast positioning signals using relatively rapid modulation, such as of light intensity level (and/or other measure of amount of light generated) in a way that does not significantly affect illumination otherwise being provided.

In an embodiment, for example, a light fixture may provide a VLC signal with a unique identifier to differentiate a light fixture from other light fixtures out of a group of light fixtures, such as in a venue, for example. A map of locations of light fixtures and corresponding identifiers, such as for a venue, for example, may be stored on a remote server, for example, to be retrieved. Thus, a mobile device may download and/or otherwise obtain a map via such a server, in an embodiment, and reference it to associate a fixture identifier with a decoded VLC signal, in an example application.

From fixture identifiers alone, for example, a mobile device may potentially determine its position to within a few meters. Likewise, with additional measurement and processing of VLC signals, in an embodiment, a mobile device may potentially further narrow its position, such as to within a few centimeters. An array of pixels (e.g., pixel elements) of a digital imager, may be employed for measuring appropriately modulating VLC signals from one or more LEDs, for example. In principle, a pixel in an array of a DI accumulates light energy coming from a relatively narrow set of physical directions. Thus, processing of signals captured via pixels of an array of a DI may facilitate a more precise determination regarding direction of arrival of light so that a mobile device, for example, may compute its position to within a few centimeters, as suggested, relative to a light fixture that has generated such modulated signals. Thus, as an example embodiment, signal processing may be employed to compute position/location, such as by using a reference map and/or by using light signal measurements, such as VLC signals, to further narrow location/position.

In one example implementation, as an illustration, different colored trans-missive films may be formed over individual electro-optic sensors in an array in a so-called Bayer pattern. Thus, the films may operate as color filters for individual electro-optic sensors. However, processing VLC signals with a full pixel array of a digital imager, for example, may consume excessive amounts of relatively scare power and/or may use excessive amounts of available memory, which also comprises a limited resource typically, such as for a mobile device. Furthermore, it is possible in some cases for use of colored trans-missive films to potentially reduce sensitivity to VLC signals.

One approach may be to adjust exposure time for electro-optic sensors of a DI based at least in part on presence of detectable VLC signals. For example, a digital imager, such as for a mobile device, in one embodiment, may employ an electronic shutter to read and/or capture a digital image one line (e.g., row) of a pixel array at a time. Exposure may, for example, in an embodiment, be adjusted by adjusting read and reset operations as rows of an array of pixels are processed. Thus, it might be possible to adjust read and reset operations so that exposure to light from a timing perspective, for example, is more conducive to VLC processing. However, one disadvantage may be that doing so may interfere with typical digital imager operation (e.g., operation to produce digital images).

Furthermore, it is noted that, while a digital imager may capture a frame of light signal measurements, for VLC communication, fewer light signal measurements (e.g., less than a frame or full array) may be employed with respect to VLC communication without significantly affecting performance, in an embodiment. Thus, potentially, in an embodiment, power consumption and/or use of limited memory resources may be reduced.

Typically, for example, mobile digital imagers, such as may be employed in a smart phone, as an illustration, may employ a rolling shutter and sensor measurements may be read line by line (e.g., row by row), as previously mentioned. Thus, relatively high frame rates, such as 240 fps, for example, may consume bandwidth over a bus which may communicate captured measurements for frames of images, such as for operations that may take place between an image processor and memory. However, since fewer measurements may be employed in connection with VLC communication, it may be desirable to communicate fewer measurements so that less bandwidth is consumed, which may result in savings in power and/or memory utilization, as suggested.

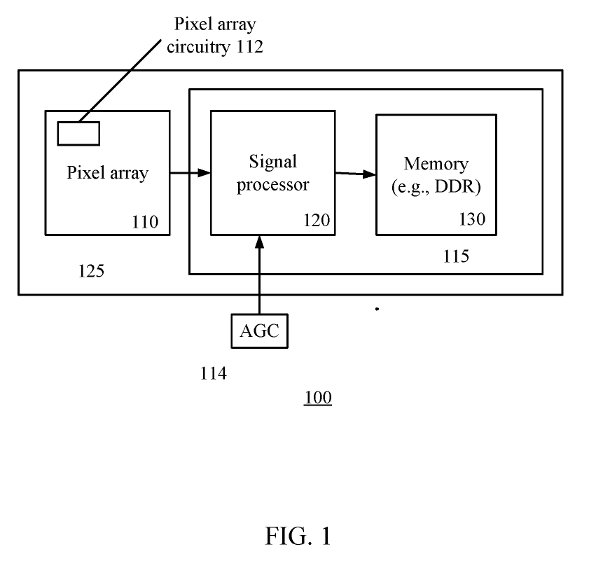

FIG. 1 is a schematic diagram illustrating a possible embodiment, such as 100, of an architecture for processing light signals (e.g., light signal measurements) received at a DI of a mobile device (e.g., in a smartphone). Thus, as illustrated in this example, an digital imager 125 may include a pixel array 110, a signal processor (SP) 120 and memory 130, such as double data rate (DDR) memory, for example, in one embodiment. As shall be described, circuitry, such as circuitry 115, which includes SP 120 and memory 130, may extract measured VLC signals and measured light component signals for an image from pixels of array 110. For example, an array, such as 110, may include pixels in which light signal measurements that are to be captured may include measurements of light component signals for an image and may include measurements of VLC signals, as described in more detail below, in an embodiment. Here, thus, light component signals refer to signal content with respect to an image, whereas VLC signals refer to signals for communication purposes. However, since respective signals (e.g., VLC signals and light component signals (e.g., for an image)) may undergo separate and distinct processing, such as “downstream” from an array of pixels in a device, such as a mobile device, it may be desirable to separate such signals or extract one from the other, such as extract VLC signals, for example, from light component signals with respect to light signal measurements, such as may be captured by pixels of an array in which one more pixels include both types of signals in a light signal measurement, for an embodiment. For example, VLC signals and light component signals, respectively, may be separately assembled from light signal measurements, again, such as light signal measurements captured by pixels of an array, so that concurrent processing may take place, in an embodiment, after separation and assembly (such as re-assembly).

Extraction, assembly and processing of signals from an array of pixels may be accomplished in a variety of approaches, with more than one described below for purposes of illustration. Of course, claimed subject matter is not intended to be limited to examples, such as those described for purposes of illustration. That is, other approaches are also possible and intended to be included within claimed subject matter. However, one possible advantage of an embodiment may include employing a DI in a manner to capture and process VLC signal measurements while also concurrently capturing and processing light component signal measurements (e.g., for a digital image). It is noted, as discussed in more detail below, this may be accomplished in an example embodiment via an implementation that includes a combination of hardware and software, for example.

Thus, for illustration, in an embodiment, SP 120 may include executable instructions to perform “front-end” processing (such as visible light front end processing (e.g., VFE)) of light component signals and processing of VLC signals, such as from light signal measurements obtained via an array, such as 110. For example, in an embodiment, an array of pixels may not necessarily be selectively addressable pixel-by-pixel. Instead, as one example, an array of pixels may be processed row by row, as previously suggested. That is, for example, light signals captured (e.g., sampled) by a row of pixels of an array, such as 110, may be provided to SP 120 so that a frame of an image, for example, may be constructed (e.g., assembled from rows of signals or signal samples), in “front end” (e.g., VFE) processing to produce an image, for example. However, again, for light signal measurements of a pixel array that may include VLC signals, it may therefore be desirable to limit light signal measurements to a subset of measurements that include VLC signal measurements and to then extract those VLC signal measurement portions to process VLC signals separately from light component signal measurements that a pixel array may also capture for the particular light signal measurements. In this context, the term ‘extract’ is used with reference to one or more signals and/or signal measurements intended to be recovered. The term refers to sufficiently recovering the one or more signals and/or signal measurements out of a greater group or set of signals and/or signal measurements so as to be able to further process the one or more signals and/or signal measurements to a state in which the one or more signals and/or signal measurements are sufficiently useful with regard to the objective of the extraction.

One possible approach may include cropping of a frame of light signal measurements, such as during pixel array sensor measurement processing. In this context, the term cropping used with reference to one or more signals and/or signal measurements refers to omitting some light signal measurements, in some situations in a systematic manner, so that a greater proportion of the remaining signals and/or signal measurements, at least on average, includes signal content being sought. Without intending to limit claimed subject matter, as a possible illustration, consider a rectangular array of pixels. Thus, in this illustration, in which row by row processing may be employed, for example, for any given light signal measurement captured, a VLC signal measurement, if present, may potentially be extracted. However, for such a rectangular array, for example, it may be that, for some light signal measurements, processing and/or storage, for example, may be omitted without a significant degradation in performance. It is noted that likewise, in an embodiment, cropping may take place using a hardware approach, using a software approach or using hardware and software together in an approach, described in more detail below.

Although claimed subject matter is not intended to be limited in this respect, one illustrative example of a pixel array implementation is described, for example, in “Design of Prototype Scientific CMOS Image Sensors,” appearing in Proceedings of SPIE, Vol. 7021, for SPIE Astronomical Telescopes and Instrumentation, held Jun. 23-38, 2008. For a pixel array able to capture light signal measurements, at the pixel sensor level, pixel array circuitry 112, as an example may comprise hardware “programmable” at the pixel level (e.g., via a “transfer”/“do not transfer” bit being set for individual pixels) so that some light signal measurements do not necessarily transfer from the array to, in effect, produce cropping.

For example, in an embodiment, light signal measurements that, on average over a region, exceed a threshold level of light intensity may be selected to be transferred (e.g., for additional processing). Of course, other approaches to selecting signals to be transferred (e.g., for additional processing), other than average intensity exceeding a threshold, may be employed and are intended to be included within claimed subject matter. Nonetheless, intensity (i.e., luminance) at least on average over a region may be helpful in terms of determining portions of a captured image that include modulating light sources within a field of via (FOV), for example. However, in an embodiment, it is likewise noted that cropping via pixel array hardware 112 (e.g., sensor level cropping) typically may be less refined and, thus, typically more limited in terms of amount of cropping to be employed at least in part as a consequence of being less flexible and/or less adjustment particular in the context of varying characteristics of captured light signal measurements, such as in real-time or nearly real-time.

For example, of a frame of light signal measurements, sensor level cropping may limit light signal measurements to be transferred to light signal measurements for selected regions or blocks that exhibit a suitable amount of light intensity. As mentioned, an average intensity above a threshold is one possible approach, although many others are possible and are intended to be included within claimed subject matter. As a non-limiting illustration, out of a frame of light signal measurements having 4000 by 3000 pixels (e.g., 12 MP), pixel array circuitry to crop light signal measurements may reduce the number of pixel measurements by about two-thirds. However, even 4 MP, in this example, may typically exceed an amount of light signal measurements to generate suitable results with respect to processing for VLC communication. For example, typically, a field of view (FOV) of less than one MP may be processed to generate suitable results in terms of performance for VLC communication.

Thus, for this illustrative example, after pixel array hardware light signal measurement reduction (e.g., hardware cropping), as just described, further savings in terms power and/or memory space usage may remain possible. Additional and more refined cropping may occur with processing via signal processor 120 in accordance with executable instructions, for an embodiment, such as after transfer of remaining light signal measurements from a pixel array (e.g., those remaining after cropping via sensor hardware within a pixel array), for example, as suggested previously. Thus, in an embodiment, additional, more flexible, light signal measurement cropping may be implemented via a signal processor, such as SP 120, operating in accordance with executable instructions with or without pixel array hardware cropping initially taking place. For example, in some embodiments, light signal measurement cropping may take place entirely via a signal processor, such as SP 120.

Signal processing via SP 120 in accordance with executable instructions may be referred to as software or firmware extraction of VLC signals (e.g., via execution of instructions by a signal processor, such as 120). Thus, in an embodiment, for example, SP 120 may execute instructions to perform extraction of VLC signals and to perform additional processing, such as field of view (FOV) assembly of VLC signals and/or frame assembly of light component signals for an image. Thus, as noted, FOV assembly of VLC signals may be performed advantageously via execution of instructions on a SP, such as 120. For example, a mobile device may be in motion as signals are captured and, likewise, movement toward or away from a light source, such as a light fixture generating modulating light signals, may lead to dynamic adjustment of a FOV as it is being assembled.

Although claimed subject matter is, of course, not limited to illustrative examples, as one example, a digital imager may include a mechanism that performs real-time or nearly real-time adjustment with respect to objects within a field of view (FOV) as a field of view (FOV) changes. This may include, as non-limiting examples, zooming capability, focus capability, etc. In some digital imagers, AGC or automatic gain control (e.g., 114 in FIG. 1), such as via an amplifier, may facility such real-time or nearly real-time adjustment. Thus, a similar approach may be employed with regard to dynamic adjustment of a FOV for a digital imager in which light signal measurements may also be employed in VLC communication. Thus, in an embodiment, SP 120, for example, may fetch and execute instructions to appropriately assemble VLC signals, such as part of VFE processing. As an example, as AGC, such as 114 in FIG. 1, is being adjusted, such as from movement of a device that includes a digital imager closer to one or more light sources or further away from one or more light sources, for example, SP 120 may employ feedback signal values generated in connection with AGC 114 to dynamically adjust one or more FOVs associated with VLC signals. Again, as an example, whereas in one situation, a FOV may comprise 640×480 pixels, depending at least in part on distance to a light source, a FOV may be adjusted to include more or fewer pixels. As mentioned, following VFE processing, for an embodiment, further processing, such as to aid positioning, may take place.

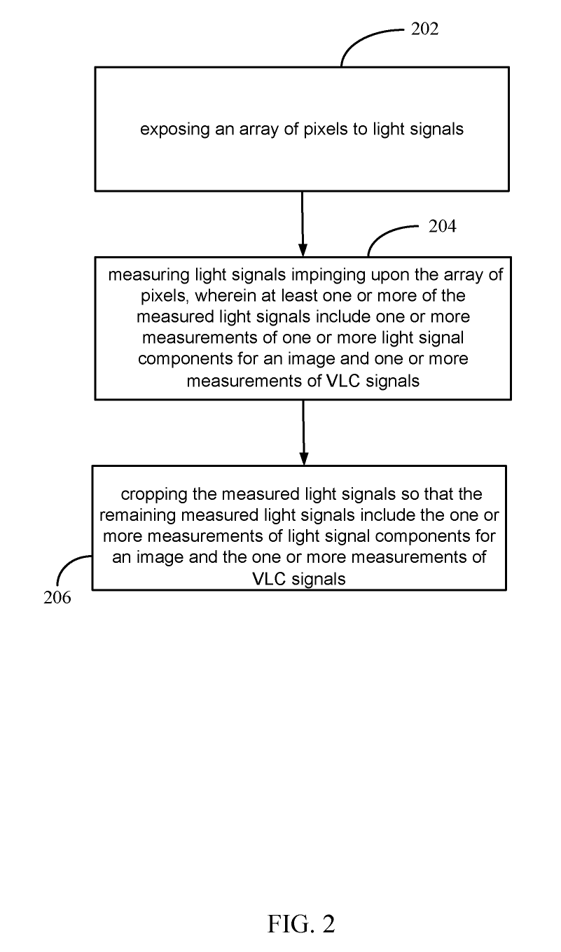

FIG. 2 illustrates a flowchart of an illustrative embodiment for measuring and processing VLC signals via a DI. It should also be appreciated that even though one or more operations are illustrated and/or may be described concurrently and/or with respect to a certain sequence, other sequences and/or concurrent operations may be employed, in whole or in part. In addition, although the description below references particular aspects and/or features illustrated in certain other figures, one or more operations, including other operations, may be performed with other aspects and/or features.

For example, referring to FIG. 2, at block 202, an array of pixels, such as 110, previously described, may be exposed to light signals. It is noted that terms such as exposed, impinging upon or the like are intended to be interchangeable without loss of meaning. At block 204, a portion of the light signals impinging upon pixels of the array may be measured, such as by signal sampling, for example. However, likewise, it is intended that measuring light signals, such as may be captured by one or more pixels of an array, may or may not include signal sampling. The term signal sampling refers to measuring a signal value level of a signal at a chosen instant in time and may, as one example, be employed, such as in situations in which a signal value level has a potentially to vary in signal value level over time.

At least one or more of the impinging light signals, in this example, generate light signal measurements that include one or more measurements of VLC signals and one or more measurements of light signal components for an image. At block 206, measured light signals may be cropped so that remaining light signal measurements, as previously discussed, include one or more measurements of one or more light signal component measurements for an image and, likewise, also include one or more measurements of VLC signals.

As previously described, a variety of embodiments are possible and intended to be included within claimed subject matter. Thus, cropping, such as described previously, may take place within a pixel array, such as before transfer of light signal measurements for further processing, such as to a signal processor, such as SP 120, for example. In addition, or alternatively, cropping may take place via SP 120 after transfer of light signal measurements. For example, SP 120 may execute instructions in which, potentially in addition to other processing, as part of VFE processing, in an embodiment, for example, cropping of light signal measurements may also be executed.

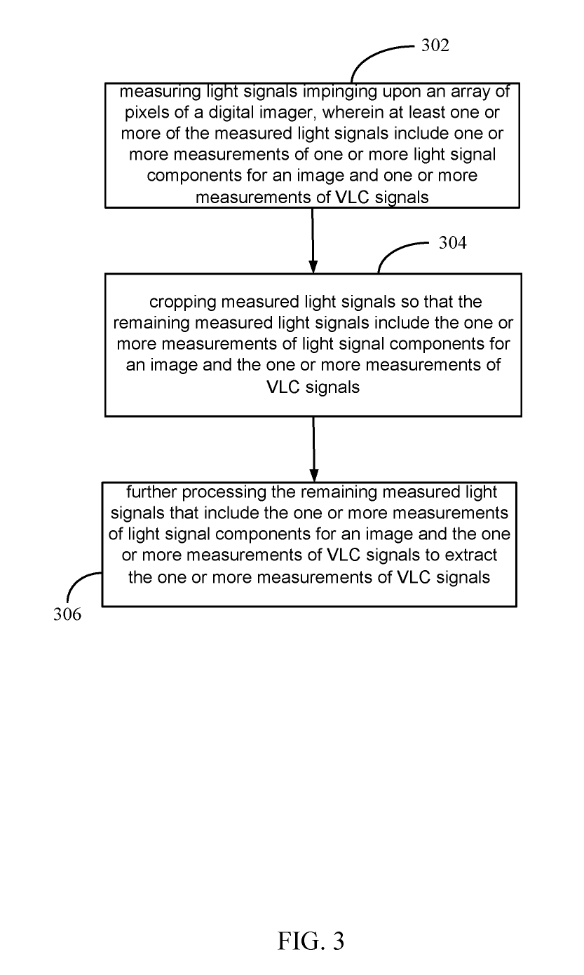

Similarly, referring to FIG. 3, after measuring impinging light signals at block 302, which may include sampling, for example, cropping of measured light signals (e.g., signal samples) may be performed at block 304. Thus, at block 306, measured signals may be cropped so that remaining light signal measurements include one or more measurements of one or more light signal component measurements for an image and also include one or more measurements of VLC signals. As previously described, a variety of embodiments are possible and intended to be included within claimed subject matter.

Thus, cropping, such as described previously, may take place within a pixel array, perhaps via pixel array hardware, such as before transfer of light signal measurements for further processing, such as to a signal processor, such as SP 120, for example. In addition, or alternatively, cropping may take place via SP 120 after transfer of light signal measurements. For example, SP 120 may execute instructions in which, potentially in addition to other processing, as part of VFE processing, in an embodiment, for example, cropping of light signal measurements may also be executed.

Likewise, at block 306, further processing may take place of remaining measured light signals that comprise light signal measurements including one or more measurements of light signal components and that also include one or more measurements of VLC signals. For example, VLC signal measurements (e.g., signal samples) which have been modulated by a light source may be demodulated. Likewise, demodulated light signals (e.g., samples) may further be decoded to obtain an identifier in an embodiment. In one example implementation, a decoded identifier may be used in positioning operations, as described previously, for example, to associate a location of a light source with a decoded identifier and to estimate a location of a mobile device, for example, based at least partially on measurements of VLC signals (e.g., samples). In another example implementation, further processing may include demodulating one or more symbols in a message or a packet, such as may be communicated.

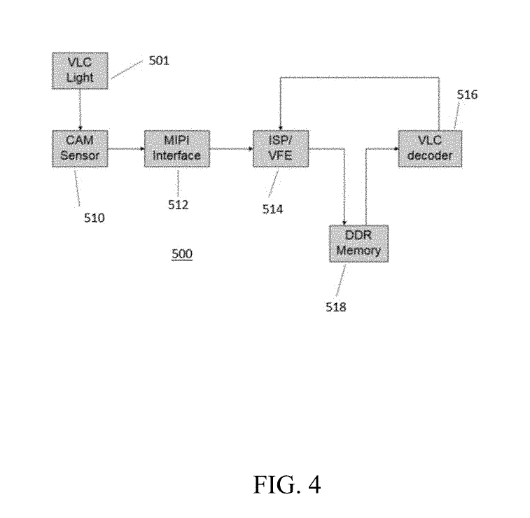

FIG. 4 is a schematic diagram illustrating another embodiment 500 of an architecture for a system including a digital imager. Embodiment 500 illustrates a more specific implementation, again provided merely as an example, and not intended to limit claimed subject matter. In many respects, it is similar to previously described embodiments, such as including an array of pixels (e.g., 110), at a sensor 510, including a signal processor, such as image signal processor (ISP) 514, and including a memory, such as DDR memory 518. FIG. 4, as shown, illustrates VLC light signals from a VLC light 501 impinging upon 510. It is noted, however, that in embodiment 500, before image signal processor 514, which may implement a visible light processing front end (VFE), as previously described, signals (e.g., light signal measurements) from a pixel array may pass via a mobile industry processor interface (MIPI), which may provide signal standardization as a convenience. It is noted that the term “MIPI” refers to any and all past, present and/or future MIPI Alliance specifications. MIPI Alliance specifications are available from the MIPI Alliance, Inc. Likewise, after front end (VFE) processing, signals may be provided to memory. VLC light signals, for example, after being provided in memory, may be decoded by decoder 516 and then may return to ISP 514 for further processing, such as described previously for use in positioning.

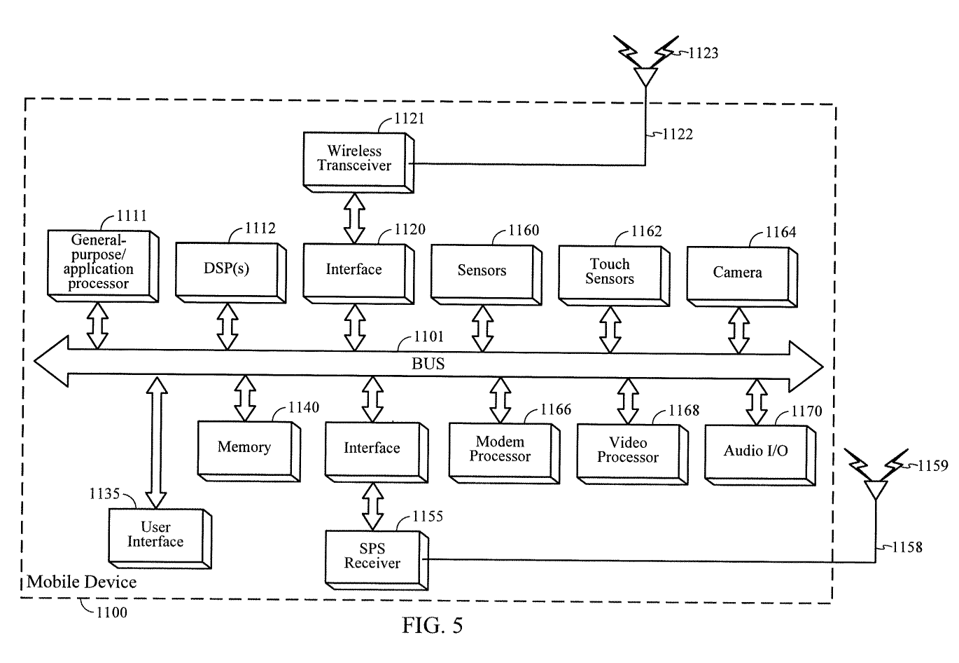

FIG. 5 is a schematic diagram illustrating features of a mobile device according to an embodiment. Subject matter shown in FIG. 5 may comprise features, for example, of a computing device, in an embodiment. It is further noted that the term computing device, in general, refers at least to one or more processors and a memory connected by a communication bus. Likewise, in the context of the present disclosure at least, this is understood to refer to sufficient structure, as are the terms “computing device,” “mobile device,” “wireless station,” “wireless transceiver device” and/or similar terms. However, if it is determined, for some reason not immediately apparent, that the foregoing understanding cannot stand, then, it is intended is to be understood and to be interpreted that, by the use of the term “computing device,” “mobile device,” “wireless station,” “wireless transceiver device” and/or similar terms, corresponding structure, material and/or acts for performing one or more actions for the present disclosure comprises at least FIGS. 2 and 3, and any associated text.

In certain embodiments, mobile device 1100 may also comprise a wireless transceiver 1121 which is capable of transmitting and receiving wireless signals 1123 via wireless antenna 1122 over a wireless communication network. Wireless transceiver 1121 may be connected to bus 1101 by a wireless transceiver bus interface 1120. Wireless transceiver bus interface 1120 may, in some embodiments be at least partially integrated with wireless transceiver 1121. Some embodiments may include multiple wireless transceivers 1121 and wireless antennas 1122 to enable transmitting and/or receiving signals according to a corresponding multiple wireless communication standards such as, for example, versions of IEEE Std. 802.11, CDMA, WCDMA, LTE, UMTS, GSM, AMPS, Zigbee, Bluetooth or other wireless communication standards mentioned elsewhere herein, just to name a few examples.

Mobile device 1100 may also comprise SPS receiver 1155 capable of receiving and acquiring SPS signals 1159 via SPS antenna 1158. For example, SPS receiver 1155 may be capable of receiving and acquiring signals transmitted from one global navigation satellite system (GNSS), such as the GPS or Galileo satellite systems, or receiving and acquiring signals transmitted from any one several regional navigation satellite systems (RNSS′) such as, for example, WAAS, EGNOS, QZSS, just to name a few examples. SPS receiver 1155 may also process, in whole or in part, acquired SPS signals 1159 for estimating a location of mobile device 1000. In some embodiments, general-purpose processor(s) 1111, memory 1140, DSP(s) 1112 and/or specialized processors (not shown) may also be utilized to process acquired SPS signals, in whole or in part, and/or calculate an estimated location of mobile device 1100, in conjunction with SPS receiver 1155. Storage of SPS or other signals for use in performing positioning operations may be performed in memory 1140 or registers (not shown). Mobile device 1100 may provide one or more sources of executable computer instructions in the form of physical states and/or signals (e.g., stored in memory such as memory 1140). In an example implementation, DSP(s) 1112 or general-purpose processor(s) 1111 may fetch executable instructions from memory 1140 and proceed to execute the fetched instructions. DSP(s) 1112 or general-purpose processor(s) 1111 may comprise one or more circuits, such as digital circuits, to perform at least a portion of a computing procedure and/or process. By way of example, but not limitation, DSP(s) 1112 or general-purpose processor(s) 1111 may comprise one or more processors, such as controllers, microprocessors, microcontrollers, application specific integrated circuits, digital signal processors, programmable logic devices, field programmable gate arrays, the like, or any combination thereof. In various implementations and/or embodiments, DSP(s) 1112 or general-purpose processor(s) 1111 may perform signal processing, typically substantially in accordance with fetched executable computer instructions, such as to manipulate signals and/or states, to construct signals and/or states, etc., with signals and/or states generated in such a manner to be communicated and/or stored in memory, for example.

Memory 1140 may also comprise a memory controller (not shown) to enable access of a computer-readable storage medium, and that may carry and/or make accessible digital content, which may include code, and/or computer executable instructions for execution as discussed above. Memory 1140 may comprise any non-transitory storage mechanism. Memory 1140 may comprise, for example, random access memory, read only memory, etc., such as in the form of one or more storage devices and/or systems, such as, for example, a disk drive including an optical disc drive, a tape drive, a solid-state memory drive, etc., just to name a few examples. Under direction of general-purpose processor(s) 1111, DSP(s) 1112, video processor 1168, modem processor 1166 and/or other specialized processors (not shown), a non-transitory memory, such as memory cells storing physical states (e.g., memory states), comprising, for example, a program of executable computer instructions, may be executed by general-purpose processor(s) 1111, memory 1140, DSP(s) 1112, video processor 1168, modem processor 1166 and/or other specialized processors for generation of signals to be communicated via a network, for example. Generated signals may also be stored in memory 1140, also previously suggested.

Memory 1140 may store electronic files and/or electronic documents, such as relating to one or more users, and may also comprise a device-readable medium that may carry and/or make accessible content, including code and/or instructions, for example, executable by general-purpose processor(s) 1111, DSP(s) 1112, video processor 1168, modem processor 1166 and/or other specialized processors and/or some other device, such as a controller, as one example, capable of executing computer instructions, for example. As referred to herein, the term electronic file and/or the term electronic document may be used throughout this document to refer to a set of stored memory states and/or a set of physical signals associated in a manner so as to thereby form an electronic file and/or an electronic document. That is, it is not meant to implicitly reference a particular syntax, format and/or approach used, for example, with respect to a set of associated memory states and/or a set of associated physical signals. It is further noted an association of memory states, for example, may be in a logical sense and not necessarily in a tangible, physical sense. Thus, although signal and/or state components of an electronic file and/or electronic document, are to be associated logically, storage thereof, for example, may reside in one or more different places in a tangible, physical memory, in an embodiment.

The term “computing device,” in the context of the present disclosure, refers to a system and/or a device, such as a computing apparatus, that includes a capability to process (e.g., perform computations) and/or store digital content, such as electronic files, electronic documents, measurements, text, images, video, audio, etc. in the form of signals and/or states. Thus, a computing device, in the context of the present disclosure, may comprise hardware, software, firmware, or any combination thereof (other than software per se). Mobile device 1100, as depicted in FIG. 5, is merely one example, and claimed subject matter is not limited in scope to this particular example.

While mobile device 1100 is one particular example implementation of a computing device, other embodiments of a computing device may comprise, for example, any of a wide range of digital electronic devices, including, but not limited to, desktop and/or notebook computers, high-definition televisions, digital versatile disc (DVD) and/or other optical disc players and/or recorders, game consoles, satellite television receivers, cellular telephones, tablet devices, wearable devices, personal digital assistants, mobile audio and/or video playback and/or recording devices, or any combination of the foregoing. Further, unless specifically stated otherwise, a process as described, such as with reference to flow diagrams and/or otherwise, may also be executed and/or affected, in whole or in part, by a computing device and/or a network device. A device, such as a computing device and/or network device, may vary in terms of capabilities and/or features. Claimed subject matter is intended to cover a wide range of potential variations. For example, a device may include a numeric keypad and/or other display of limited functionality, such as a monochrome liquid crystal display (LCD) for displaying text, for example. In contrast, however, as another example, a web-enabled device may include a physical and/or a virtual keyboard, mass storage, one or more accelerometers, one or more gyroscopes, and/or a display with a higher degree of functionality, such as a touch-sensitive color 2D or 3D display, for example.

Also shown in FIG. 5, mobile device 1100 may comprise digital signal processor(s) (DSP(s)) 1112 connected to the bus 1101 by a bus interface 1110, general-purpose processor(s) 1111 connected to the bus 1101 by a bus interface 1110 and memory 1140. Bus interface 1110 may be integrated with the DSP(s) 1112, general-purpose processor(s) 1111 and memory 1140. In various embodiments, actions may be performed in response execution of one or more executable computer instructions stored in memory 1140 such as on a computer-readable storage medium, such as RAM, ROM, FLASH, or disc drive, just to name a few example. The one or more instructions may be executable by general-purpose processor(s) 1111, DSP(s) 1112, video processor 1168, modem processor 1166 and/or other specialized processors. Memory 1140 may comprise a non-transitory processor-readable memory and/or a computer-readable memory that stores software code (programming code, instructions, etc.) that are executable by processor(s) 1111, DSP(s) 1112, video processor 1168, modem processor 1166 and/or other specialized processors to perform functions described herein. In a particular implementation, wireless transceiver 1121 may communicate with general-purpose processor(s) 1111, DSP(s) 1112, video processor 1168 or modem processor through bus 1101. General-purpose processor(s) 1111, DSP(s) 1112 and/or video processor 1168 may execute instructions to execute one or more aspects of processes, such as discussed above in connection with FIGS. 2 and 3, for example.

Also shown in FIG. 5, a user interface 1135 may comprise any one of several devices such as, for example, a speaker, microphone, display device, vibration device, keyboard, touch screen, just to name a few examples. In a particular implementation, user interface 1135 may enable a user to interact with one or more applications hosted on mobile device 1100. For example, devices of user interface 1135 may store analog or digital signals on memory 1140 to be further processed by DSP(s) 1112, video processor 1168 or general purpose/application processor 1111 in response to action from a user. Similarly, applications hosted on mobile device 1100 may store analog or digital signals on memory 1140 to present an output signal to a user. In another implementation, mobile device 1100 may optionally include a dedicated audio input/output (I/O) device 1170 comprising, for example, a dedicated speaker, microphone, digital to analog circuitry, analog to digital circuitry, amplifiers and/or gain control. It should be understood, however, that this is merely an example of how an audio I/O may be implemented in a mobile device, and that claimed subject matter is not limited in this respect. In another implementation, mobile device 1100 may comprise touch sensors 1162 responsive to touching or pressure on a keyboard or touch screen device.

Mobile device 1100 may also comprise a dedicated device 1164 for capturing still or moving imagery. Dedicated device 1164 may comprise, for example a sensor (e.g., charge coupled device or CMOS device), lens, analog to digital circuitry, frame buffers, just to name a few examples. In one implementation, additional processing, conditioning, encoding or compression of signals representing captured images may be performed at general purpose/application processor 1111 or DSP(s) 1112. Alternatively, a dedicated video processor 1168 may perform conditioning, encoding, compression or manipulation of signals representing captured images. Additionally, dedicated video processor 1168 may decode/decompress stored image signals (e.g., states) for presentation on a display device (not shown) on mobile device 1100.

Mobile device 1100 may also comprise sensors 1160 coupled to bus 1101 which may include, for example, inertial sensors and environmental sensors. Inertial sensors of sensors 1160 may comprise, for example accelerometers (e.g., collectively responding to acceleration of mobile device 1100 in three dimensions), one or more gyroscopes or one or more magnetometers (e.g., to support one or more compass applications). Environmental sensors of mobile device 1100 may comprise, for example, temperature sensors, barometric pressure sensors, ambient light sensors, digital imagers, microphones, just to name few examples. Sensors 1160 may generate analog or digital signals that may be stored in memory 1140 and processed by DPS(s) or general purpose/application processor 1111 in support of one or more applications such as, for example, applications directed to positioning or navigation operations.

In a particular implementation, mobile device 1100 may comprise a dedicated modem processor 1166 capable of performing baseband processing of signals received and down converted at wireless transceiver 1121 or SPS receiver 1155. Similarly, dedicated modem processor 1166 may perform baseband processing of signals to be upconverted for transmission by wireless transceiver 1121. In alternative implementations, instead of having a dedicated modem processor, baseband processing may be performed by a general purpose processor or DSP (e.g., general purpose/application processor 1111 or DSP(s) 1112). It should be understood, however, that these are merely examples of structures that may perform baseband processing, and that claimed subject matter is not limited in this respect.

In the context of the present disclosure, the term “connection,” the term “component” and/or similar terms are intended to be physical, but are not necessarily always tangible. Whether or not these terms refer to tangible subject matter, thus, may vary in a particular context of usage. As an example, a tangible connection and/or tangible connection path may be made, such as by a tangible, electrical connection, such as an electrically conductive path comprising metal or other electrical conductor, that is able to conduct electrical current between two tangible components. Likewise, a tangible connection path may be at least partially affected and/or controlled, such that, as is typical, a tangible connection path may be open or closed, at times resulting from influence of one or more externally derived signals, such as external currents and/or voltages, such as for an electrical switch. Non-limiting illustrations of an electrical switch include a transistor, a diode, etc. However, a “connection” and/or “component,” in a particular context of usage, likewise, although physical, can also be non-tangible, such as a connection between a client and a server over a network, which generally refers to the ability for the client and server to transmit, receive, and/or exchange communications, as discussed in more detail later.

In a particular context of usage, such as a particular context in which tangible components are being discussed, therefore, the terms “coupled” and “connected” are used in a manner so that the terms are not synonymous. Similar terms may also be used in a manner in which a similar intention is exhibited. Thus, “connected” is used to indicate that two or more tangible components and/or the like, for example, are tangibly in direct physical contact. Thus, using the previous example, two tangible components that are electrically connected are physically connected via a tangible electrical connection, as previously discussed. However, “coupled,” is used to mean that potentially two or more tangible components are tangibly in direct physical contact. Nonetheless, is also used to mean that two or more tangible components and/or the like are not necessarily tangibly in direct physical contact, but are able to co-operate, liaise, and/or interact, such as, for example, by being “optically coupled.” Likewise, the term “coupled” may be understood to mean indirectly connected in an appropriate context. It is further noted, in the context of the present disclosure, the term physical if used in relation to memory, such as memory components or memory states, as examples, necessarily implies that memory, such memory components and/or memory states, continuing with the example, is tangible.

Unless otherwise indicated, in the context of the present disclosure, the term “or” if used to associate a list, such as A, B, or C, is intended to mean A, B, and C, here used in the inclusive sense, as well as A, B, or C, here used in the exclusive sense. With this understanding, “and” is used in the inclusive sense and intended to mean A, B, and C; whereas “and/or” can be used in an abundance of caution to make clear that all of the foregoing meanings are intended, although such usage is not required. In addition, the term “one or more” and/or similar terms is used to describe any feature, structure, characteristic, and/or the like in the singular, “and/or” is also used to describe a plurality and/or some other combination of features, structures, characteristics, and/or the like. Furthermore, the terms “first,” “second” “third,” and the like are used to distinguish different aspects, such as different components, as one example, rather than supplying a numerical limit or suggesting a particular order, unless expressly indicated otherwise. Likewise, the term “based on” and/or similar terms are understood as not necessarily intending to convey an exhaustive list of factors, but to allow for existence of additional factors not necessarily expressly described.

Wireless communication techniques described herein may be employed in connection with various wireless communications networks such as a wireless wide area network (“WWAN”), a wireless local area network (“WLAN”), a wireless personal area network (WPAN), and so on. In this context, a “wireless communication network” comprises multiple devices or nodes capable of communicating with one another through one or more wireless communication links. The term “network” and “communication network” may be used interchangeably herein. A VLC communication network may comprise a network of devices employing visible light communication. A WWAN may comprise a Code Division Multiple Access (“CDMA”) network, a Time Division Multiple Access (“TDMA”) network, a Frequency Division Multiple Access (“FDMA”) network, an Orthogonal Frequency Division Multiple Access (“OFDMA”) network, a Single-Carrier Frequency Division Multiple Access (“SC-FDMA”) network, or any combination of the above networks, and so on. A CDMA network may implement one or more radio access technologies (“RATs”) such as cdma2000, Wideband-CDMA (“W-CDMA”), to name just a few radio technologies. Here, cdma2000 may include technologies implemented according to IS-95, IS-2000, and IS-856 standards. A TDMA network may implement Global System for Mobile Communications (“GSM”), Digital Advanced Mobile Phone System (“D-AMPS”), or some other RAT. GSM and W-CDMA are described in documents from a consortium named “3rd Generation Partnership Project” (“3GPP”). Cdma2000 is described in documents from a consortium named “3rd Generation Partnership Project 2” (“3GPP2”). 3GPP and 3GPP2 documents are publicly available. 4G Long Term Evolution (“LTE”) communications networks may also be implemented in accordance with claimed subject matter, in an aspect. A WLAN may comprise an IEEE 802.11x network, and a WPAN may comprise a Bluetooth network, an IEEE 802.15x, for example. Wireless communication implementations described herein may also be used in connection with any combination of WWAN, WLAN or WPAN.

Regarding aspects related to a network, including a communications and/or computing network, a wireless network may couple devices, including client devices, with the network. A wireless network may employ stand-alone, ad-hoc networks, mesh networks, Wireless LAN (WLAN) networks, cellular networks, and/or the like. A wireless network may further include a system of terminals, gateways, routers, and/or the like coupled by wireless radio links, and/or the like, which may move freely, randomly and/or organize themselves arbitrarily, such that network topology may change, at times even rapidly. A wireless network may further employ a plurality of network access technologies, including a version of Long Term Evolution (LTE), WLAN, Wireless Router (WR) mesh, 2nd, 3rd, or 4th generation (2G, 3G, or 4G) cellular technology and/or the like, whether currently known and/or to be later developed. Network access technologies may enable wide area coverage for devices, such as computing devices and/or network devices, with varying degrees of mobility, for example.

As used herein, the term “access point” is meant to include any wireless communication station and/or device used to facilitate access to a communication service by another device in a wireless communications system, such as, for example, a WWAN, WLAN or WPAN, although the scope of claimed subject matter is not limited in this respect. In another aspect, an access point may comprise a WLAN access point, cellular base station or other device enabling access to a WPAN, for example. Likewise, as previously discussed, an access point may also engage in VLC communication.

In the preceding description, various aspects of claimed subject matter have been described. For purposes of explanation, specifics, such as amounts, systems and/or configurations, as examples, were set forth. In other instances, well-known features were omitted and/or simplified so as not to obscure claimed subject matter. While certain features have been illustrated and/or described herein, many modifications, substitutions, changes and/or equivalents will now occur to those skilled in the art. It is, therefore, to be understood that the appended claims are intended to cover all modifications and/or changes as fall within claimed subject matter.

1. An apparatus comprising:
a digital imager comprising:
an array of pixels to capture an image frame of light signal measurements,
wherein at least some pixels are to measure light component signals for an image and also to measure Visible Light Communication (VLC) signals; and
further comprising circuitry to crop the image frame of light signal measurements so that, for light signal measurements that remain, extraction of VLC signal measurements from light component signal measurements is able to be employed.

2. The apparatus of claim 1, wherein the circuitry to crop the image frame of light signal measurements comprises circuitry within the array of pixels so as to omit pixels of light signal measurements from the image frame of light signal measurements to be transferred from the array of pixels.

3. The apparatus of claim 2, wherein the circuitry within the array of pixels so as to omit pixels of light signal measurements from the image frame of light signal measurements to be transferred from the array of pixels comprises pixel level programmable hardware.

4. The apparatus of claim 1, wherein the circuitry to crop the image frame of light signal measurements includes a processor to extract measured VLC signals from the light signal measurements that remain after being cropped.

5. The apparatus of claim 4, wherein the processor to extract the measured VLC signals from the light signal measurements that remain is also to further crop the light signal measurements so that fewer pixels are to be processed for VLC signals.

6. The apparatus of claim 5, wherein the processor to extract the measured VLC signals from the light signal measurements that remain is to further crop the light signal measurements based at least in part on selected regions of pixels of the array having an average intensity above a threshold level.

7. The apparatus of claim 5, wherein the processor to extract the measured VLC signals from the light signal measurements is further to dynamically construct one or more field of view (FOV) portions of the image frame of light signal measurements in which the light signal measurements of the one or more FOV portions include the VLC signal measurements.

8. The apparatus of claim 7, wherein the processor to dynamically construct the one or more FOV portions is responsive at least in part to an automatic gain control (AGC) to provide AGC feedback signal values.

9. An apparatus comprising:
means for exposing an array of pixels to light signals;
means for measuring the light signals impinging upon the array of pixels, wherein one or more of the measured light signals impinging upon the array of pixels include one or more measurements of one or more light signal components for an image and also include one or more measurements of visible light communication (VLC) signals; and
means for cropping the measured light signals impinging upon the array of pixels so that remaining measured light signals include the one or more measurements of one or more light signal components for the image and include the one or more measurements of VLC signals.

10. The apparatus of claim 9, wherein the means for cropping the measured light signals impinging upon the array of pixels includes:
means for dynamically constructing one or more field of view (FOV) portions of an image frame in which measured light signals of the one or more FOV portions include VLC signal measurements; and
means for processing only light signal measurements of the one or more FOV portions.

11. The apparatus of claim 10, wherein the array of pixels is included in a digital imager having an automatic gain control (AGC), and wherein the means for dynamically constructing the one or more FOV portions of the image frame employs feedback signals from the AGC at least in part to form the one or more FOV portions.

12. A method comprising:
measuring light signals impinging upon an array of pixels of a digital imager,
wherein at least one or more of the measured light signals impinging upon the array of pixels include one or more measurements of one or more light signal components for an image and also include one or more measurements of visible light communication (VLC) signals;
cropping the measured light signals impinging upon the array of pixels so that remaining measured light signals include the one or more measurements of one or more light signal components for the image and also include the one or more measurements of VLC signals; and
further processing the remaining measured light signals that include the one or more measurements of one or more light signal components for the image and also include the one or more measurements of VLC signals to extract the one or more measurements of VLC signals.

13. The method of claim 12, wherein cropping the measured light signals impinging upon the array of pixels includes:
dynamically constructing one or more field of view (FOV) portions of an image frame in which light signal measurements of the one or more FOV portions include VLC signal measurements; and
processing only light signal measurements of the one or more FOV portions.

14. The method of claim 13, wherein the array of pixels is included in the digital imager, the digital imager further having an automatic gain control (AGC), and wherein the dynamically constructing the one or more FOV portions of the image frame employs feedback signals from the AGC at least in part to form the one or more FOV portions.

15. The method of claim 12, wherein cropping the measured light signals impinging upon the array of pixels includes:
constructing one or more field of view (FOV) portions of an image frame in which measured light signals of the one or more FOV portions include VLC signal measurements; and
processing only light signal measurements of the one or more FOV portions.

16. An article comprising: a non-transitory storage medium comprising executable instructions stored thereon, the instructions being accessible from the non-transitory storage medium as physical memory states on one or more physical memory devices, the one or more physical memory devices to be coupled to one or more processors able to execute the instructions stored as physical memory states, one or more of the physical memory devices also able to store binary digital signal quantities, if any, as physical memory states, that are to result from execution of the executable instructions on the one or more processors; wherein the executable instructions to:
measure light signals to imping upon an array of pixels, wherein at least one or more of the measured light signals to imping upon the array of pixels to include one or more measurements of one or more light signal components for an image and also to include one or more measurements of visible light communication (VLC) signals;
crop the measured light signals to imping upon the array of pixels so that measured light signals to remain after cropping include the one or more measurements of one or more light signal components for the image and also include the one or more measurements of VLC signals; and
further process the measured light signals to remain after cropping for extraction of the one or more measurements of VLC signals.

17. The article of claim 16, wherein the executable instructions are further to:
dynamically construct one or more field of view (FOV) portions of an image frame in which light signal measurements of the one or more FOV portions to include VLC signal measurements; and
process only light signal measurements of the one or more FOV portions.

18. The article of claim 17, wherein the array of pixels is included in a digital imager,
the digital imager further having an automatic gain control (AGC), and wherein the executable instructions are further to employ feedback signals from the AGC at least in part to form the one or more FOV portions.

19. The article of claim 16, wherein the at least some pixels of the array of pixels comprise electro-optic sensors.

20. The article of claim 19, wherein the at least some electro-optic sensors comprise at least one of the following: photodiodes; CMOS sensors or CCD sensors, or a combination thereof.

21. The article of claim 16, wherein the executable instructions are further to:
construct one or more field of view (FOV) portions of an image frame in which measured light signals of the one or more FOV portions to include VLC signal measurements; and
process only light signal measurements of the one or more FOV portions.
